(19) United States
(12) Patent Application Publication
(10) Pub. No.: US 2003/0015936 A1
(43) Pub. Date: Jan. 23, 2003

(54) Electrostatic actuator

(75) Inventors: Euisik Yoon, Daejeon (KR); Jun-Bo Yoon, Daejeon (KR); Hyung-Kew Lee, Gunpo (KR)

Correspondence Address: OLIFF & BERRIDGE, PLC, P.O. BOX 19928, ALEXANDRIA, VA, 22320, US

(73) Assignee: Korea Advanced Institute of Science And Technology, Daejeon (KR)

(21) Appl. No.: 10/194,013

(22) Filed: Jul. 15, 2002

(30) Foreign Application Priority Data
Jul. 18, 2001 (KR) 2001-43075

(51) Int. Cl. H02N 1/00

(52) U.S. Cl. 310/309

(57) ABSTRACT

Disclosed is an electrostatic actuator. A multi-layered auxiliary electrode is further arranged between main electrode and actuating body, and positive charge or negative charge is applied to main electrode, respective auxiliary electrodes, and actuating body such that electrostatic attractive force is generated between auxiliary electrodes adjacent to the main electrode, between adjacent auxiliary electrodes, and between auxiliary electrodes adjacent to the actuating body. According to the invention, distance between the induced charges is shortened, so that electrostatic attractive force therebetween increases, thereby capable of maintaining an actuating range equal to or larger than the conventional electrostatic actuator. The electrostatic actuator according to the present invention can be applied to various MEMS devices, such as an optical switch in which a mirror is formed in the actuator, a radio frequency (RF) switch, or a variable electrostatic capacitor, or the like.

### BACKGROUND OF THE INVENTION

1. Field of the Invention

The present invention relates to an electrostatic actuator, and more particularly, to an electrostatic actuator in which multi-layered auxiliary electrodes are installed such that electrostatic attractive force increase due to induced charges.

2. Description of the Related Art

Electrostatic actuation is an actuation way in which a voltage is applied to two layered conductors to induce charge on the conductors, and the force acting between the induced charges is used as an actuating source. This electrostatic actuation is widely used around the actuation of micro devices using the micro machining.

A general electrostatic actuator includes an electrode fixed on a substrate, a column fixed on the substrate, a torsion spring of which one end is supported and fixed to the column, and an actuating body connected with the other end of the torsion spring. Accordingly, when voltages are respectively applied to the electrode and the actuating body such that charges having different polarities are induced in the electrode and the actuating body, the actuator is actuated by attractive force acting between the electrode and the actuating body. Then, since the restoring force of the torsion spring acts in an opposite direction to the electrostatic attractive force acting between the charges, the actuator is moved to a position where the restoring force of the torsion spring is in a parallel state with the electrostatic attractive force.

Applications of these electrostatic actuators include “TORSION MIRROR USING ELECTROSTATIC FORCE” which was published by Fujita et al., in Journal of Microelectromechanical System, December 1996, pp 231 “OPTICAL SWITCH USING ELECTROSTATIC ACTUATION” which was published by Ming C. Wu et al., in Journal of Lightwave Technology, pp7, January 1999, etc. Also, Takayuki Iseki et al., discloses a content related with the actuation of a reflective mirror for picture display using an electrostatic attractive force in U.S. Pat. No. 6,198,565 entitled “LIGHT DEFLECTION ELEMENT AND DISPLAY APPARATUS USING SAME”.

As described above, in case of general electrostatic actuators, force acting between two charges is largely influenced by the distance between the two charges. Accordingly, a higher voltage is needed in proportion as the distance between the two charges is distant. In order to actuate the actuator having the conventional structure to a desired degree, there is a drawback in that a high voltage ranged from a few ten to a few hundred volts has to be applied.

### SUMMARY OF THE INVENTION

Accordingly, the present invention has been made to solve the above problems and it is an object of the present invention to provide an electrostatic actuator capable of lowering the actuating voltage and maintaining an actuating range by decreasing the distance between the induced charges.

To accomplish the above object, there is provided an electrostatic actuator in accordance with one aspect of the present invention. The electrostatic actuator includes: an insulating substrate; a main electrode installed at a selected region of one surface of the insulating substrate, to which positive charge or negative charge are applied; an auxiliary actuating part having an auxiliary electrode of which lower surface faces with upper surface of the main electrode, the auxiliary actuating part being installed on the substrate such that a selected region of the auxiliary electrode is moved toward the main electrode by an electrostatic attractive force between the main electrode and the auxiliary electrode if a charge having an opposite polarity to the charge applied to the main electrode is applied to the auxiliary electrode from an outside; and a main actuating part having an actuating body made of conductor, and of which lower surface faces with upper surface of the auxiliary electrode, the main actuating part being installed on the substrate such that a selected region of the actuating body is moved toward the auxiliary electrode by an electrostatic attractive force between the auxiliary electrode and the actuating body if a charge having an opposite polarity to the charge applied to the auxiliary electrode is applied to the actuating body from the outside.

Preferably, the electrostatic actuator further comprises a plurality of actuating parts such that the plurality of auxiliary electrodes are positioned between the auxiliary electrode and the actuating body, and wherein the positive charge or the negative charge is applied to the main electrode, the respective auxiliary electrodes, and the actuating body such that the electrostatic attractive force is generated between the auxiliary electrodes adjacent to the main electrode, between the adjacent auxiliary electrodes, and between the actuating body and the auxiliary electrode.

Preferably, the main actuating part comprises the auxiliary electrode, a first torsion spring made of conductor, of which one end is connected with the auxiliary electrode, and a first column connected with other end of the first torsion spring in order to support and fix the first torsion spring, the first column being fixed on the substrate. The main actuating part comprises the actuating body, a second torsion spring made of conductor, of which one end is connected with the actuating body, and a second column connected with other end of the second torsion spring in order to support and fix the second torsion spring, the second column being fixed on the substrate.

Preferably, the main electrode, the auxiliary electrode and the actuating body comprise an insulating film formed at a selected region thereof such that no discharge is generated although the main electrode and the auxiliary electrode are in contact with each other, or the auxiliary electrode and the actuating body are in contact with each other.

According to another aspect of the invention, there is provided an electrostatic actuator. The electrostatic actuator includes: an insulating substrate; a main electrode installed at a selected region of one surface of the insulating substrate, to which positive charge or negative charge are applied; an auxiliary actuating part having an auxiliary electrode of which lower surface faces with upper surface of the main electrode, the auxiliary actuating part being installed on the substrate such that the auxiliary electrode is moved toward the main electrode by an electrostatic attractive force between the main electrode and the auxiliary electrode if a charge having an opposite polarity to the charge applied to the main electrode is applied to the auxiliary electrode from an outside; and a main actuating part having an actuating body made of conductor, and of which lower surface faces with upper surface of the auxiliary electrode, the main actuating part being installed on the substrate such that the actuating body is moved toward the auxiliary electrode by an electrostatic attractive force between the auxiliary electrode and the actuating body if a charge having an opposite polarity to the charge applied to the auxiliary electrode is applied to the actuating body from the outside.

Preferably, the electrostatic actuator further comprises the plurality of auxiliary actuating parts such that the plurality of auxiliary electrodes are positioned between the auxiliary electrode and the actuating body, the positive charge or the negative charge is applied to the main electrode, the respective auxiliary electrodes, and the actuating body such that the electrostatic attractive force is generated between the auxiliary electrodes adjacent to the main electrode, between the adjacent auxiliary electrodes, and between the actuating body and the auxiliary electrode.

Preferably, the auxiliary actuating part comprises the auxiliary electrode, a first spring made of conductor, arranged in a radial symmetry around the auxiliary electrode, of which one end is connected with the auxiliary electrode, and a first column connected with other end of the first spring one to one in order to support and fix the first torsion spring, the first column being fixed on the substrate in the radial symmetry around the auxiliary electrode, and the main actuating part comprises the actuating body, a second spring made of conductor, arranged in the radial symmetry around the auxiliary electrode, of which one end is connected with the actuating body, and a second column connected with other end of the second spring one to one in order to support and fix the second spring, the second column being fixed on the substrate in the radial symmetry around the actuating body.

Preferably, the main electrode, the auxiliary electrode and the actuating body comprise an insulating film formed at a selected region thereof such that no discharge is generated although the main electrode and the auxiliary electrode are in contact with each other, or the auxiliary electrode and the actuating body are in contact with each other.

According to further another aspect of the present invention, there is provided an electrostatic actuator. The electrostatic actuator comprises: an insulating substrate; an auxiliary actuating part having an electrode to which positive charge or negative charge is applied, a first column fixed on the substrate such that one side surface of the first column faces with one side surface of the electrode apart from the first column, and a first elastic body made of conductor connecting a rear end of the electrode with a rear end of the first column; and a main actuating part made of conductor, having a first actuating body of which both side surfaces are apart from one side surface of the first column and one side surface of the electrode and face with the one side surface of the first column and the one side surface of the electrode, a second actuating body made of conductor, of which one side surface is apart from other side surface of the electrode and faces with the other side surface of the electrode, a second column of which one side surface is apart from other side surface of the first column and faces with the other side surface of the first column, a second elastic body made of conductor connecting a front end of the first actuating body with a front end of the second actuating body, and a third elastic body made of conductor connecting the front end of the first actuating body with a front end of the second column.

Preferably, the auxiliary actuating part further comprises a plurality of second electrodes spaced apart from each other and sequentially arranged in parallel with the electrode, and a fourth elastic body connecting rear ends of the second electrodes adjacent to the electrode and connecting the rear ends of the second electrodes adjacent to each other, and the main actuating part further comprises a plurality of third actuating bodies spaced apart from each other and sequentially arranged in parallel with the second actuating body, and a fifth elastic body connecting front ends of the third actuating bodies adjacent to the second actuating body and connecting the front ends of the third actuating bodies adjacent to each other, and the second electrodes of the auxiliary actuating part and the third actuating bodies of the main actuating part are spaced apart from each other and are alternatively arranged.

Preferably, the first, second, third, fourth and fifth elastic bodies are made of a spring.

Preferably, the main electrode, the second electrode, the first actuating body, the second actuating body and the third actuating body comprise insulating films formed at selected regions thereof such that no discharge is generated although the main electrode, the second electrode, the first actuating body, the second actuating body and the third actuating body are in contact with each other.

### BRIEF DESCRIPTION OF THE DRAWINGS

The above and other objects, features and other advantages of the present invention will be more clearly understood from the following detailed description taken in conjunction with the accompanying drawings, in which:

FIGS. 1a to 3 are schematic views for illustrating embodiments in accordance with the present invention.

### DETAILED DESCRIPTION OF THE PREFERRED EMBODIMENT

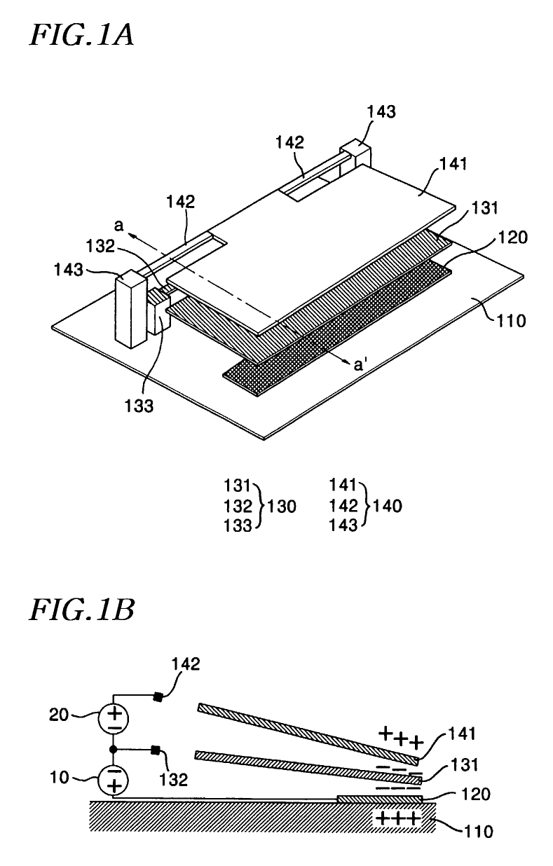

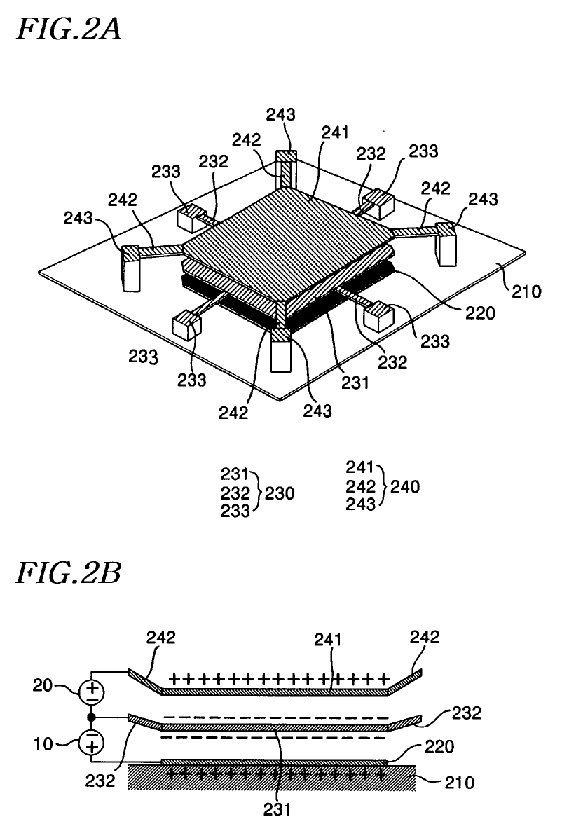

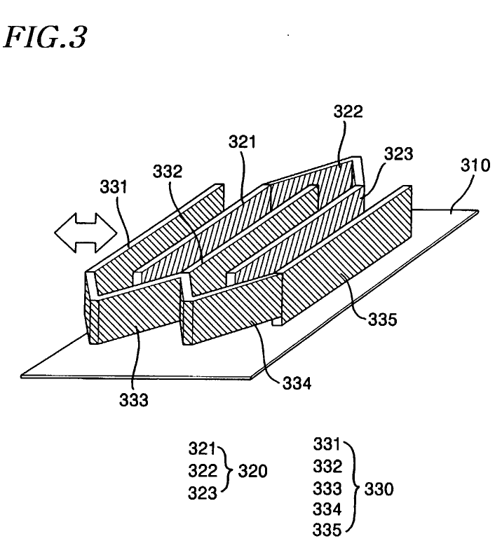

Now, preferred embodiments of the present invention will be described in detail with reference to the annexed drawings. FIG. 1a is a perspective view for illustrating an electrostatic actuator in accordance with one preferred embodiment of the present invention, FIG. 1b is a sectional view taken along the line a-a′ of FIG. 1a, FIG. 2a is a perspective view for illustrating an electrostatic actuator in accordance with another preferred embodiment of the present invention, FIG. 2b is a sectional view for illustrating operations of the electrostatic actuator shown in FIG. 2a, and FIG. 3 is a perspective view of an electrostatic actuator in accordance with further another preferred embodiment of the present invention.

### Embodiment 1

Referring to FIG. 1a, an electrostatic actuator includes an insulating substrate 110, a main electrode 120 fixedly installed on the insulating substrate 110, an auxiliary actuating part 130 having an auxiliary electrode 131 fixedly installed on the substrate 110, and a main actuating part 140 having an actuating body 141 made of conductor, and fixedly installed on the substrate 110. Here, the auxiliary actuating part 130 is installed such that a lower surface of the auxiliary electrode 131 faces with a upper surface of the main electrode 120 apart by a certain interval. Positive charge or negative charge is applied to the main electrode 120 and a charge having an opposite polarity to the charge applied to the main electrode 120 is applied to the auxiliary electrode 131, so that an electrostatic attractive force is generated to move a selection region of the auxiliary electrode 131 toward the main electrode 120.

The main actuating part 140 is installed such that a lower surface of the actuating body 141 faces with a upper surface of the auxiliary electrode 131 apart by a certain interval. Charges having different polarities are respectively applied to the actuating body 141 and the auxiliary electrode 131, so that an electrostatic attractive force is generated to move a selection region of the actuating body 141 toward the auxiliary electrode 131.

The auxiliary actuating part 130 includes the auxiliary electrode 131, a first column 133 made of conductor and fixed on the substrate 110 so as not to be in contact with the main electrode 120, and a first torsion spring 132 made of conductor, of which one end is connected with the auxiliary electrode and the other end is connected with the first column 133, respectively. At this time, the first torsion spring 132 is installed one by one at both corners of one edge of the auxiliary electrode 131 such that the auxiliary electrode maintains equilibrium and is floated over the main electrode 120, and the first column 133 for supporting and fixing the respective first torsion springs 132 is also installed one by one on the substrate 110.

The main actuating part includes the actuating body 141, a second column 143 made of conductor and fixed on the substrate 110 so as not to be in contact with the main electrode 120 and the auxiliary actuating part 130, and a second torsion spring 142 made of conductor, of which one end is connected with the actuating body 141 and the second column 143, respectively. Likewise, the second torsion spring 142 is installed one by one at both corners of side ends of the actuating body 141 such that the actuating body 141 maintains equilibrium and is floated over the auxiliary electrode 131, and the second column 143 for supporting and fixing the respective second torsion springs 142 is also installed one by one on the substrate 110.

Next, there is described an operation of the electrostatic actuator shown in FIG. 1a with reference to FIG. 1b.

Referring to FIG. 1b, as positive charge is applied to the main electrode 120 and the actuating body 141 using electrostatic voltage sources 10 and 20 and negative charge is applied to the auxiliary electrode 131, an electrostatic attractive force acts between the positive charge and the negative charge. The electrostatic attractive force attracts the main electrode 120 and the auxiliary electrode 131, and the auxiliary electrode attracts the actuating body 132. At this time, since the actuating body 141 and the auxiliary electrode 131, as shown in FIG. 1a, are fixed through the first and second torsion springs 132 and 142, the respective torsion springs 132 and 142 are twisted and thus the actuating body 141 and the auxiliary electrode 131 are rotated downward around the torsion springs 132 and 142, so that the actuating body 141 and the auxiliary electrode 131 become close to each other.

When compared with the conventional electrostatic actuator consisting of the main electrode and the main actuating part, the electrostatic actuator of the present invention makes it possible to obtain a desired drive range at a low voltage although the distance between the main electrode and the actuator is the same as that of the conventional electrostatic actuator.

### Embodiment 2

The aforementioned embodiment 1 relates to the electrostatic actuator in which the actuating body and the auxiliary electrode are rotatably moved with the respective torsion springs as the central axis, while the present embodiment 2 relates to a vertical electrostatic actuator in which the auxiliary electrode and the actuating body are all moved up and down.

Referring to FIG. 2a, an electrostatic actuator includes an insulating substrate 210, a main electrode 220 fixedly installed on the insulating substrate 210, an auxiliary actuating part 230 having an auxiliary electrode 231 fixedly installed on the substrate 210, and a main actuating part 240 having an actuating body 241 made of conductor, and fixedly installed on the substrate 110. Here, the auxiliary actuating part 230 is installed such that a lower surface of the auxiliary electrode 231 faces with a upper surface of the main electrode 220 apart by a certain interval. Positive charge or negative charge is applied to the main electrode 220 and a charge having an opposite polarity to the charge applied to the main electrode 220 is applied to the auxiliary electrode 231, so that an electrostatic attractive force is generated to move the auxiliary electrode 231 toward the main electrode 220.

The main actuating part 240 is installed such that a lower surface of the actuating body 241 faces with a upper surface of the auxiliary electrode 231 apart by a certain interval. Charges having different polarities are respectively applied to the actuating body 241 and the auxiliary electrode 231, so that an electrostatic attractive force is generated to move the actuating body 241 toward the auxiliary electrode 231.

The auxiliary actuating part 230 includes the auxiliary electrode 231, a first column 233 made of conductor and fixed on the substrate 210 so as not to be in contact with the main electrode 220, and first springs 232 made of conductor, and arranged in a radial symmetry. At this time, one side ends of the first springs 232 are connected with the auxiliary electrode 231 and the other side ends thereof are connected with the first columns 233 one by one.

The main actuating part 240 includes the actuating body 241, second columns 243 made of conductor, fixed on the substrate 210 so as not to be in contact with the main electrode 220 and the auxiliary actuating part 230, and arranged in a radial symmetry, and second springs 242 made of conductor, and arranged in the radial symmetry. At this time, one side ends of the second springs 242 are connected with the actuating body 241 and the other side ends thereof are connected with the second columns 243 one by one.

Next, there is described an operation of the electrostatic actuator shown in FIG. 2a with reference to FIG. 2b.

Referring to FIG. 2b, as positive charge is applied to the main electrode 220 and the actuating body 241 using electrostatic voltage sources 10 and 20 and negative charge is applied to the auxiliary electrode 231, an electrostatic attractive force acts between the positive charge and the negative charge. The electrostatic attractive force allows the main electrode 120 to attract the auxiliary electrode 231 and the auxiliary electrode 231 to attract the actuating body 241. At this time, since the actuating body 241 and the auxiliary electrode 231, as shown in FIG. 2a, are fixed through the first and second springs 232 and 242 connected in the radial symmetry, the respective springs 232 and 242 are deflected downward and thus the actuating body 241 and the auxiliary electrode 231 are moved downward.

While the embodiments 1 and 2 describe that the auxiliary electrode is positioned between the main electrode and the actuating body one by one, they are not limited thereto.

Accordingly, in an application where a plurality of auxiliary electrodes are needed, the auxiliary actuating part described in the embodiments 1 and 2 may be further installed so as to be positioned between the main electrode and the actuating body. At this time, positive charge or negative charge is applied to the main electrode, the respective auxiliary electrodes and the actuating body such that electrostatic attractive force is generated between the main electrode and the auxiliary electrode adjacent to the main electrode, between the auxiliary electrodes adjacent to each other, and between the actuating body and the auxiliary electrode adjacent to the actuating body.

Also, in the embodiments 1 and 2, in order to prevent occurrence of discharge due to the contact of the main electrode, the auxiliary electrode and the actuating body, it is desirous to form an insulating film at selected regions of the main electrode, the auxiliary electrode, and the actuating body.

### Embodiment 3

The present embodiment relates to a horizontal electrostatic actuator in which the actuating body is horizontally moved on the same plane, i.e., the substrate.

Referring to FIG. 3, a horizontal electrostatic actuator includes an insulating substrate 310, an auxiliary actuating part 320 having an electrode 321 to which positive charge or negative charge is applied from an outside, and installed on the substrate 310, and a main actuating part 330 having first and second actuating bodies 331 and 332 made of conductor. At this time, a lower surface of the electrode 321 of the auxiliary actuating part 320 is directed toward the substrate 310, and one side surface of the first and second actuating bodies 331 and 332 of the main actuating part 330 faces with one side surface of the electrode 321 of the auxiliary actuating part 320 apart by a certain distance. The auxiliary actuating part 320 and the main actuating part 330 are constituted such that the first and second actuating bodies 331 and 332, and the electrode 321 are moved left and right when charges having different polarities from each other are applied to the first and second actuating bodies 331 and 332, and the electrode 321.

The auxiliary actuating part 320 includes the electrode 321, a first column 323, and a first spring 322. The first column 323 is fixed on the substrate 310 such that one side surface of the first column 323 faces apart by a certain distance with one side surface of the electrode 321. The first spring 322 is made of conductor connecting a rear end of the electrode 321 with a rear end of the first column 323.

The main actuating part 330 includes the first actuating body 331, the second actuating body 332, a second column 335, a second spring 333 and a third spring 334. The first actuating body 331 is positioned such that both side surfaces thereof face apart by a certain distance with the first column 323 and one side surface of the electrode 321, and the second actuating body 332 is positioned such that one side surface thereof faces apart by a certain distance with the other surface of the electrode 321.

The second column 335 is fixed on the substrate 310 such that one side surface thereof faces apart by a certain distance with the other side surface of the first column 323. The second spring 333 connects the front end of the first actuating body 331 with the front end of the second actuating body 332, and the third spring 334 connects the front end of the first actuating body 331 with the front end of the second column 335. At this time, the first actuating body 331, the second actuating body 332, the second spring 333 and the third spring 334 are all made of conductor.

Accordingly, between the first actuating body 331 and the second actuating body 332 is arranged the electrode 321, between the electrode 321 and the first column 323 is arranged the first actuating body 331, outside the electrode 321 is arranged the second actuating body 332, and outside the first column 323 is arranged the second column 335.

At this time, in case that an electrostatic attractive force is generated between the first and second actuating bodies 331 and 332, and the electrode 321, it is desirous that the first spring 322 has a V-letter shape that is protruded forward, and the second and third springs 333 and 334 have a V-letter shape that is protruded backward.

Next, there is described an operation of the horizontal electrostatic actuator.

As positive charge is applied to the first and second actuating bodies 331 and 332 and negative charge is applied to the electrode 321 by applying an electrostatic voltage to the first and second actuating bodies 331 and 332, and the electrode 321, an electrostatic attractive force is generated between the actuating bodies 331 and 332, and the electrode 321. The generated electrostatic attractive force allows the first, second and third springs 322, 333, 334 to be deflected, so that the spacing between the first and second actuating bodies 331 and 332, and the electrode 321 narrows. Accordingly, the second actuating body 332 that is placed outermost performs a horizontal movement with a large displacement.

While the present embodiment describes the actuator having one electrode and two actuating bodies, it is necessarily not limited thereto.

Accordingly, in an application where the electrode and the actuating body are further needed, the electrode and the actuating body are sequentially and alternatively arranged so as to be apart from the outer portion of the second actuating body, i.e., another side surface that is not the side surface of the second actuating body where the second actuating body faces with the electrode. Also, the front ends of the second actuating body and the further provided actuating bodies are sequentially connected using a spring, and the rear ends of the electrode and the further provided electrodes are sequentially connected using a spring such that the actuating body is outermost arranged. Accordingly, by applying the positive charge or the negative charge like the embodiment 3, the outermost actuating body performs a horizontal movement with a very large displacement.

At this time, in order to prevent occurrence of discharge due to the contact of the electrodes to which charge is applied, and the actuating bodies, it is desirous to form an insulating film at selected regions of the electrode, and the actuating bodies.

The electrostatic actuators of the present invention can be made of nickel or copper using a plating process or an MUMP (Multi User Mems Process) in which a structure is fabricated using several layered thin polysilicon films. A sacrificial layer for forming the structure includes insulator, such as silicon oxide film or nitride film, high molecular polymer such as photoresist, or metal that is a different kind than the structure.

As described previously, according to the electrostatic actuators of the present invention, multi-layered auxiliary electrodes are arranged between the main electrode and the actuating body, to decrease the distance between the induced charges, so that electrostatic attractive force therebetween increases, thereby capable of maintaining an actuating range equal to or larger than the conventional electrostatic actuator.

The electrostatic actuator according to the present invention can be applied to various MEMS devices, such as an optical switch in which a mirror is formed in the actuator, a radio frequency (RF) switch, or a variable electrostatic capacitor, or the like.

Although the invention has been shown and described with reference to the certain preferred embodiment thereof, it will be understood by those skilled in the art that various changes in form and details may be made therein without departing from the spirit and scope of the invention as defined by the appended claims.

What is claimed is:

1. An electrostatic actuator comprising:
an insulating substrate;
a main electrode installed at a selected region of one surface of the insulating substrate, to which positive charge or negative charge is applied;
an auxiliary actuating part having an auxiliary electrode of which lower surface faces with upper surface of the main electrode, the auxiliary actuating part being installed on the substrate such that a selected region of the auxiliary electrode is moved toward the main electrode by an electrostatic attractive force between the main electrode and the auxiliary electrode if a charge having an opposite polarity to the charge applied to the main electrode is applied to the auxiliary electrode from an outside; and
a main actuating part having an actuating body made of conductor, and of which lower surface faces with upper surface of the auxiliary electrode, the main actuating part being installed on the substrate such that a selected region of the actuating body is moved toward the auxiliary electrode by an electrostatic attractive force between the auxiliary electrode and the actuating body if a charge having an opposite polarity to the charge applied to the auxiliary electrode is applied to the actuating body from the outside.

2. The electrostatic actuator as claimed in claim 1, further comprising a plurality of auxiliary actuating parts such that the plurality of auxiliary electrodes are positioned between the auxiliary electrode and the actuating body, and wherein the positive charge or the negative charge is applied to the main electrode, the respective auxiliary electrodes, and the actuating body such that the electrostatic attractive force is generated between the auxiliary electrodes adjacent to the main electrode, between the adjacent auxiliary electrodes, and between the actuating body and the auxiliary electrode.

3. The electrostatic actuator as claimed in claim 1 or 2, wherein the auxiliary actuating part comprises the auxiliary electrode, a first torsion spring made of conductor, and of which one end is connected with the auxiliary electrode, and a first column connected with other end of the first torsion spring in order to support and fix the first torsion spring, the first column being fixed on the substrate,
wherein the main actuating part comprises the actuating body, a second torsion spring made of conductor, and of which one end is connected with the actuating body, and a second column connected with other end of the second torsion spring in order to support and fix the second torsion spring, the second column being fixed on the substrate.

4. An electrostatic actuator comprising:
an insulating substrate;
a main electrode installed at a selected region of one surface of the insulating substrate, to which positive charge or negative charge is applied;
an auxiliary actuating part having an auxiliary electrode of which lower surface faces with upper surface of the main electrode, the auxiliary actuating part being installed on the substrate such that the auxiliary electrode is moved toward the main electrode by an electrostatic attractive force between the main electrode and the auxiliary electrode if a charge having an opposite polarity to the charge applied to the main electrode is applied to the auxiliary electrode from an outside; and
a main actuating part having an actuating body made of conductor, and of which lower surface faces with upper surface of the auxiliary electrode, the main actuating part being installed on the substrate such that the actuating body is moved toward the auxiliary electrode by an electrostatic attractive force between the auxiliary electrode and the actuating body if a charge having an opposite polarity to the charge applied to the auxiliary electrode is applied to the actuating body from the outside.

5. The electrostatic actuator as claimed in claim 4, further comprising the plurality of auxiliary actuating parts such that the plurality of auxiliary electrodes are positioned between the auxiliary electrode and the actuating body, the positive charge or the negative charge is applied to the main electrode, the respective auxiliary electrodes, and the actuating body such that the electrostatic attractive force is generated between the auxiliary electrodes adjacent to the main electrode, between the adjacent auxiliary electrodes, and between the actuating body and the auxiliary electrode.

6. The electrostatic actuator as claimed in claim 4 or 5, wherein the auxiliary actuating part comprises the auxiliary electrode, a first spring made of conductor, arranged in a radial symmetry around the auxiliary electrode, of which one end is connected with the auxiliary electrode, and a first column connected with other end of the first spring one to one in order to support and fix the first torsion spring, the first column being fixed on the substrate in the radial symmetry around the auxiliary electrode, and
the main actuating part comprises the actuating body, a second spring made of conductor, arranged in the radial symmetry around the auxiliary electrode, of which one end is connected with the actuating body, and a second column connected with other end of the second spring one to one in order to support and fix the second spring, the second column being fixed on the substrate in the radial symmetry around the actuating body.

7. The electrostatic actuator as claimed in claim 1 or 4, wherein the main electrode, the auxiliary electrode and the actuating body comprise an insulating film formed at a selected region thereof such that no discharge is generated although the main electrode and the auxiliary electrode are in contact with each other, or the auxiliary electrode and the actuating body are in contact with each other.

8. An electrostatic actuator comprising:
an insulating substrate;
an auxiliary actuating part having an electrode to which positive charge or negative charge is applied, a first column fixed on the substrate such that one side surface of the first column faces with one side surface of the electrode apart from the first column, and a first elastic body made of conductor connecting a rear end of the electrode with a rear end of the first column; and
a main actuating part made of conductor, having a first actuating body of which both side surfaces are apart from one side surface of the first column and one side surface of the electrode and face with the one side surface of the first column and the one side surface of the electrode, a second actuating body made of conductor, of which one side surface is apart from other side surface of the electrode and faces with the other side surface of the electrode, a second column of which one side surface is apart from other side surface of the first column and faces with the other side surface of the first column, a second elastic body made of conductor connecting a front end of the first actuating body with a front end of the second actuating body, and a third elastic body made of conductor connecting the front end of the first actuating body with a front end of the second column.

9. The electrostatic actuator as claimed in claim 8, wherein the auxiliary actuating part further comprises a plurality of second electrodes spaced apart from each other and sequentially arranged in parallel with the electrode, and a fourth elastic body connecting rear ends of the second electrodes adjacent to the electrode and connecting the rear ends of the second electrodes adjacent to each other,
the main actuating part further comprises a plurality of third actuating bodies spaced apart from each other and sequentially arranged in parallel with the second actuating body, and a fifth elastic body connecting front ends of the third actuating bodies adjacent to the second actuating body and connecting the front ends of the third actuating bodies adjacent to each other, and
the second electrodes of the auxiliary actuating part and the third actuating bodies of the main actuating part are spaced apart from each other and are alternatively arranged.

10. The electrostatic actuator as claimed in claim 8 or 9, wherein the first, second, third, fourth and fifth elastic bodies are made of a spring.

11. The electrostatic actuator as claimed in claim 8 or 9, wherein the main electrode, the second electrode, the first actuating body, the second actuating body and the third actuating body comprise insulating films formed at selected regions thereof such that no discharge is generated although the main electrode, the second electrode, the first actuating body, the second actuating body and the third actuating body are in contact with each other.
